(19) United States
(12) Patent Application Publication
(10) Pub. No.: US 2016/0364492 A1
(43) Pub. Date: Dec. 15, 2016

(54) SYSTEMS AND METHODS FOR A VIRAL SOCIAL NETWORK

(71) Applicant: Duby, LLC, Denver, CO (US)

(72) Inventors: Russell Thomas, Englewood, CO (US); Alec Rochford, Denver, CO (US)

(21) Appl. No.: 15/181,205

(22) Filed: Jun. 13, 2016

Related U.S. Application Data
(60) Provisional application No. 62/174,737, filed on Jun. 12, 2015.

(51) Int. Cl. G06F 17/30; H04L 29/06; H04L 29/08

(52) U.S. Cl. CPC G06F 17/30867; G06F 17/3053; H04L 67/306; H04L 65/403

(57) ABSTRACT

Systems and methods for a viral social network may comprise propagating content within an online social network that is communicatively coupled to a communication network from a first user to a plurality of additional users of the online social network. The viral social network may receive over the network the content to be propagated from a content creation device. The viral social network may propagate the content over the network to the plurality of additional users associated with the social network, wherein the amount the content is propagated among the plurality of users is determined according to an influence metric relating to the first user.

### CROSS-REFERENCES TO RELATED APPLICATIONS

This application claims the benefit of U.S. Provisional Patent Application No. 62/174,737, filed Jun. 12, 2015, and incorporates the disclosure by reference. To the extent that the present disclosure conflicts with any referenced application, however, the present disclosure is to be given priority.

### BACKGROUND OF INVENTION

Traditional social networks rely on open communication between all its users. For example, each particular user may share content that has the potential to reach each and every other user of the social network. Current methods of limiting which user receives content in a social medium often takes the form of a friends list (e.g., a predetermined list of users who will receive your shared content) or some other predetermined list from which only a limited number of users may receive shared content.

Such methods are overly restrictive, however, and require constant vigilance to maintain and upkeep. Furthermore, current social networks do not have adequate systems and processes in place to handle unwanted (or otherwise low quality) content. Most often, the only way to get rid of unwanted content is to either manually remove, hide, and/or disable the content, or to report the content to a system administrator such that they may remove the unwanted content.

### SUMMARY OF THE INVENTION

Systems and methods for a viral social network may propagate content within an online social network that is communicatively coupled to a communication network from a first user to a plurality of additional users of the online social network. The viral social network may receive over the network the content to be propagated from a content creation device and propagate the content over the network to the plurality of additional users associated with the social network, wherein the amount the content is propagated among the plurality of users is determined according to an influence metric relating to the first user.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures.

FIG. 1 representatively illustrates an exemplary embodiment of the viral social network and its components in accordance with the present technology;

FIG. 2 representatively illustrates a flowchart depicting an exemplary process utilized by the viral social network in propagating content within the social network in accordance with the present technology;

FIG. 3 representatively illustrates a flowchart depicting a proximity-based content distribution scheme;

FIG. 4 representatively illustrates a flowchart depicting a proximity-based content distribution scheme utilizing a user's individual share rate (influence metric);

FIG. 5 representatively illustrates a flowchart depicting assigning a quality rating to the shared content by additional users of the viral social network; and

FIG. 6 representatively illustrates a flowchart depicting a viral social network utilizing a quality rating in determining a user's individual share rate (influence metric).

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various process steps, apparatus, systems, methods, etc. In addition, the present technology may be practiced in conjunction with any number of systems and methods for social networking. Further, the present technology may employ any number of conventional techniques for connecting, transmitting, and receiving information to and from a server using a communication network.

The particular implementations shown and described are illustrative of the technology and its best mode and are not intended to limit the scope of the present technology in any way. For the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Systems and methods for a viral social network according to various aspects of the present technology may operate in conjunction with any suitable system configured to facilitate the transmission of information among users of the system. Various representative implementations of the present technology may be operate in conjunction with any suitable network, electronic device, computer system, network system, and/or the like. In one embodiment, the technology may be configured for a social network that can automatically filter out unwanted content based on how the content is rated amongst the user base receiving the content. As the content receives more and more negative ratings, it may cease to propagate within the social network and disappear overtime. In contrast, content that is highly rated by the user base may be propagated within a larger user base within the social network and remain visible for a longer duration.

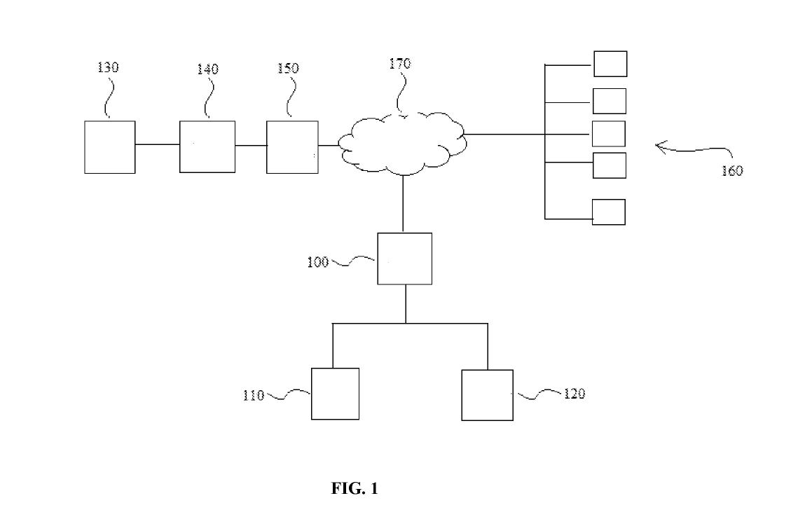

Referring to FIG. 1, in one embodiment, a viral social network 100 may be communicatively coupled to a communication network 170, a server 110, and a database 120. The server 110 and the database 120 may store information and data related to users of the viral social network 100 as well as additional information and/or data associated with the viral social network 100. A user 130 may utilize a content creation device 140 to create a limited interaction viral (LIV) message 150 (also referred to as “content”). The LIV message 150 (i.e., content) may be transmitted from the content creation device 140 to the viral social network 100 over the communication network 170. The viral social network 100 may then transmit the LIV message 150 to additional users 160 of the viral social network 100 via the communication network 170 according to a predetermined set of criteria.

In one embodiment, the predetermined set of criteria may comprise one or more elements selected to provide limits on a propagation rate of the LIV message 150 to the additional users 160 and/or a proximity range from the content creation device to which the LIV message 150 is propagated. For example, LIV messages 150 deemed to comprise high quality and/or highly rated by the additional users 160 content may be transmitted to additional users 160 while LIV messages 150 deemed to comprise low quality and/or poorly rated content may be stopped, limited, and/or otherwise suppressed from further propagation throughout the viral social network 100.

The action taken by the additional users 160 in response to the propagated content may affect an individual share rate (ISR), also known as the user's 130 influence metric, of the user 130 who created and/or shared the content. A user's 130 ISR may increase or decrease in relation to the perceived quality of their shared content in the LIV message 150. The viral social network 100 may take into account the user's 130 ISR to determine how many additional users 160 receive LIV messages 150 from the user 130 and/or how far geographically the user's 130 LIV message 150 is propagated from the content creation device.

In one embodiment, the viral social network 100 may be communicatively linked to the server 110 and the database 120. The server 110 may store information and data relating to the viral social network 100 and/or facilitate the operation of the viral social network 100. The server 100 may comprise any suitable systems or components to operate a social network. For example, the server 110 may host a website where users may register and/or otherwise associate themselves with the viral social network 100. Each user may be associated with the viral social network 100 with a unique identifier such as a UserID.

Once the user 130 registers with the viral social network 100, the user 130 may access a separate page associated with their account. This page may be the user's 130 profile where an additional plurality of users 160 may view information about a particular user 130. From the user's 130 profile, the user 130 may have access to their ISR score, a history of previously created and/or shared LIV messages 150 and other content, and the ability to view the predetermined geographical proximity range of where their LIV messages 150 can be shared.

The server 110 may also facilitate the propagation of LIV messages 150 to additional users 160 of the viral social network 100. For example, the server 110 may access information needed to determine which additional users 160 the LIV message 150 should be propagated to, and the server 110 may further maintain and keep track of the quality of the LIV message 150 as it is propagated through the viral social network 100. For example, if the server 110 determines that the LIV message 150 has failed to meet a certain threshold quality rating, the viral social network 100 may remove, restrict, and/or otherwise inhibit the LIV message 150 and its content from being further propagated throughout the viral social network 100.

In one embodiment, the database 120 may be communicatively linked to the server 110. The database 120 may store information associated with various components of the viral social network 100 such as user accounts, LIV messages 150, and information relating to the server 110. The database 110 may further store metrics related to the viral social network 100. For example, the database 120 may store statistics related to LIV message 150 propagation, users 130, 160, predetermined geographical proximity range information, and/or any other data that may be relevant. The database 120 may provide information and/or data to the viral social network 100 (and its components) in response to requests from the server 110, the user 130, the additional users 160, and/or any other system or device communicatively linked to the social network 100.

In one embodiment, the database 120 may be accessed by other entities. For example, advertisers may access the database 120 to pull necessary information and/or data. Advertisers may access the database 120 to learn information about where LIV messages 150 are being shared, the subject matter of LIV messages 150, which LIV messages 150 are being rated as good quality and which are being rated as poor quality. This information may allow advertisers to more specifically target their advertisements.

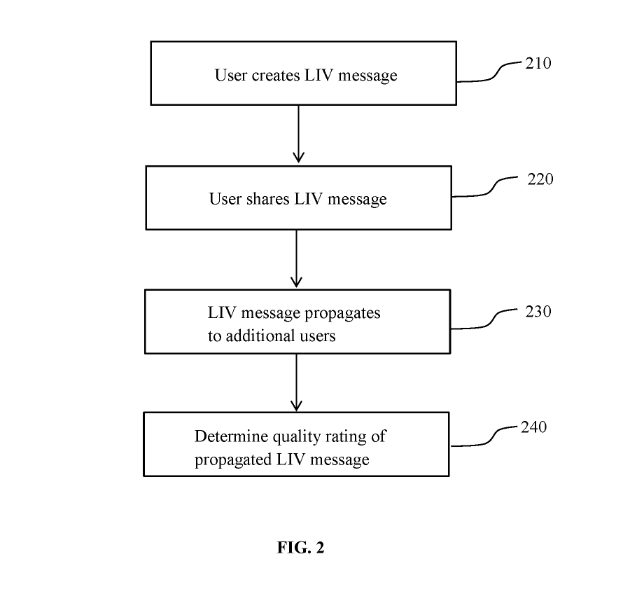

Referring now to FIGS. 1 and 2, in one embodiment, the viral social network 100 may operate by receiving, from the user 130, over the communication network, the content to be propagated (210, 220). The content may be propagated to a plurality of additional users 160 associated with the viral social network 100 (230), wherein the amount the content is propagated among the plurality of users is determined according to an influence metric relating to the user 130. The extent to which the content is propagated throughout the social network 100 may be determined according to elements that comprise both the predetermined geographical proximity range as well as the number of additional users 160 to which the content will be propagated. For example, the viral social network 100 may determine that only additional users 160 within a 3-mile radius of the sharing user 130 is configured to receive the LIV message 150. Additionally, the viral social network 100 may further determine that the LIV message 150 is only going to be propagated to one hundred additional users 160.

Once propagated to additional users 160 within a certain predetermined geographical proximity range, the server 110 may determine a quality rating of the content according to any suitable criteria, such as a reaction of the additional users 160 to the content (240). The viral social network 100 may update the user's 130 influence metric according to the quality rating assigned by the plurality of additional users 160.

Referring again to FIG. 1, in one embodiment, the user 130 may create a limited interactive viral (LIV) message 150 using the content creation device 140. The content creation device 140 may comprise any electronic device configured to create, download, save, merge, and/or otherwise associate itself with content. For example, the content creation device 140 may comprise a mobile phone, a portable computing device, a webcam, a laptop PC, a desktop PC, a video recorder, and the like.

The content creation device 140 may be include or interact with any suitable system or device to communicatively link the content creation device 140 to the viral social network 100, the server 110, the database 120, and/or the communication network 170. For example, the content creation device 140 may comprise a network adapter to communicatively link the content creation device 140 to the server 110 on which the viral social network 100 resides. The content creation device 140 may upload and/or otherwise transmit information and/or data to and from the server 110 over the communication network 170.

The LIV message 150 may comprise any suitable data or information, such as text, audio, video, links, or a combination of the same. The LIV message 150 may comprise an original content created by the user 130 or the LIV message 150 may comprise an already-existing content. For example, the user 130 may create a new LIV message 150 comprising a picture captured using the camera device of a mobile phone, or the user 130 may create a LIV message 150 comprising a link, or embedded media, to a video stored on a website. The LIV message 150 may further comprise a hybrid content wherein the user 130 adds additional content to an already-existing content. For example, the user may choose to edit an already-existing video file by adding some special effects to the video file.

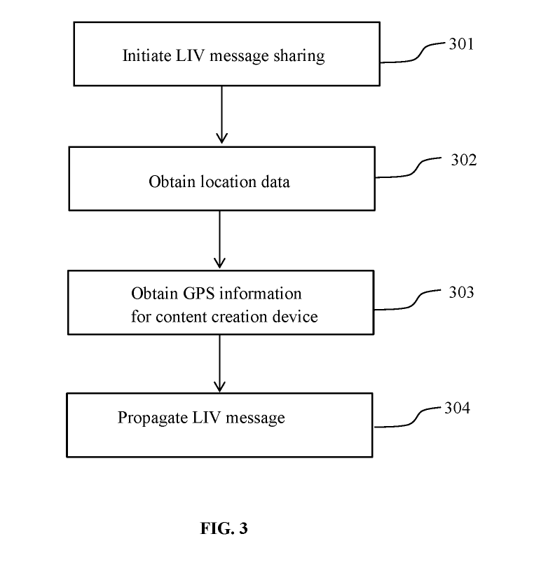

Now referring to FIG. 3, in one embodiment, the viral social network 100 may propagate the LIV message 150 over the communication network 170 to a plurality of additional users 160 associated with the viral social network 100 according to any appropriate factors, such as the sharing user's 130 ISR, a predetermined proximity range, a quality rating of the LIV message 150, and/or the like. Additional statistics and metrics related to the LIV message 150 as it is being propagated throughout the social network 100 may be monitored and/or stored by the social network 100 to allow the social network 100 to adjust the user's 130 ISR.

In one embodiment, the LIV message 150 may be shared with the additional users 160 according to a proximity-based content distribution (PBCD) scheme (301). In contrast to a traditional non-PBCD scheme wherein content is delivered to all available users 130, 160 of the viral social network 100, a PBCD scheme seeks to distribute content to a limited number of users within a geographic range.

For example, the PBCD scheme of the viral social network 100 may factor in the predetermined geographical proximity range in determining which additional users 160 the LIV message 150 is to be distributed. For example, it may be the case that only users within a certain geographical area (e.g., within a 5-mile radius, within a certain city limit, within certain zip codes, etc.) may receive the LIV message 150.

In one embodiment, a predetermined geographical proximity range of where the LIV message 150 may be propagated to may be determined by the viral social network 100 according to any suitable criteria, such as the geographical location of the content creation device 140 (302) or the subject matter of the content. For example, the viral social network 100 may set a predetermined geographical proximity range based on the GPS location of the content creation device 140 (303) when the LIV message 150 is initially created and/or uploaded to the server 110. This initial determination may remain even as the content creation device 140 changes its geographical location over time.

In one embodiment, LIV messages 150 may be transmitted, and propagated within the viral social network 100, in substantially real-time. The viral social network 100 may relay information from one source to another in substantially real-time. For example, the communication network 170 to which the viral social network 100 is connected may relay information in real-time. When a user 130 shares a LIV message 150 with the viral social network 100 using the content creation device 140, the viral social network 100 may transfer the information from the content creation device 140 to the communication network 170 in substantially real-time.

In one embodiment, LIV messages 150 may be propagated within the viral social network 100 anonymously (304). The LIV message 150 may be configured such that no personal or otherwise identifying information is transferred/shared along with the LIV message 150. For example, when the LIV message 150 is shared with the viral social network 100, all metadata may be removed from the LIV message 150, such as which user created the LIV message 150, the location/geotag from which the LIV message 150 was created, the timestamp of the LIV message, and the like.

Removing/hiding the metadata may be done automatically by the viral social network 100 prior to sharing the LIV message with the additional users 160. The server 110 and/or database 120 may store the erased/hidden metadata for various purposes. For example, metadata may be used to generate statistics/metrics regarding who is creating the LIV messages 150, the location from which the LIV messages 150 are created, the additional users 160 who receive the LIV messages 150, and the like. The viral social network 100 may provide this statistical/metric information to third party entities, such as advertisers who may use the information to better calibrate and adjust their advertising campaigns while preventing the same information from being seen by the additional users 160.

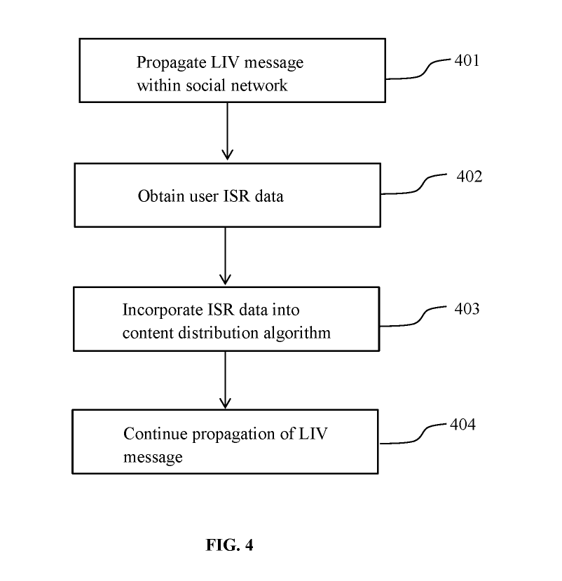

Referring now to FIG. 4, in one embodiment, once the LIV message 150 is shared by the first user 130, the LIV message 150 may propagate within the viral social network 100 via the communication network 170 to the additional users 160 according to the PBCD scheme outlines above (401). Another factor in addition to the PBCD scheme that may be utilized in determining the propagation of the LIV message 150 may be the individual share rate (ISR) of the user 130, also referred to interchangeably as the “influence metric” of the user 130.

In one embodiment, the viral social network 100 may be configured with any suitable system to quantify the user's 130 ISR metric. For example, the ISR may comprise a raw number, a coefficient, parametric bounds, a letter grade, a percentage, and/or the like. All users within the viral social network 100 may begin with an initial ISR, such as zero or other value with no positive or negative indicators on their ISR. As various users create and share content, their ISR may change in relation to the rest of the user base of the viral social network 100.

In one embodiment, the user's ISR may comprise a ratio determined from the propagation rate of the user's 130 LIV message 150. The ratio may comprise a comparison of the total number of times the user's 130 LIV message 150 was propagated to the additional users 160 (and so on from that user) against the total number of times the user's 130 message was not propagated further (i.e., stopped). For example, if a first user 130 propagates their LIV message 150 to ten additional users, and nine out of ten of the additional users 160 go on to share that same LIV message 150, then the ratio may be nine to one (nine passes and one no-pass). Likewise, if the first user 130 propagates their LIV message 150 to ten additional users, and five out of ten of the additional users 160 go on to share that same LIV message 150, then the ratio may be one to one (five passes and five no-pass).

The user's 130 ISR, or “influence metric,” may be factored into determining how many additional users 160 the LIV message 150 is initially shared with, as well as serving as a metric to evaluate the overall quality of content shared by the user 130 (402). The user's 130 ISR may fluctuate based on the quality rating of the LIV messages 150 shared as assigned by additional users 160 of the viral social network 100. A higher ISR may result in the user's 130 LIV message 150 being shared with more additional users 160 compared to a lower ISR. A higher ISR may also result in the user 130 being able to share the LIV message 150 in a larger predetermined geographical proximity range.

In one embodiment, the user's 130 ISR may be determined using a predetermined date range. For example, a user's ISR may be determined using data from the past 30-days, 3-months, 1-year, and/or the like. The date range may be fixed or the data range may comprise a moving range. For example, in a fixed date range scheme, the viral social network 100 may determine a user's 130 ISR using the months of the year as predetermined cutoffs. In a moving range, the viral social network 100 may determine a user's 130 ISR from the past X-number of days from the current date. For example, if the user 130 shares content on July 1^{st}, the viral social network may determine the user's 130 ISR from a calculation based on the previous 90 days.

In one embodiment, the user's ISR may be incorporated along with the PBCD scheme (403) in determining the predetermined geographical proximity range of where the LIV message 150 may be propagated before ultimately propagating the LIV message 150 (404). For example, the viral social network 100 may be configured such that newly registered users and/or users with a lower ISR are limited geographically where they can share the LIV message 150 (e.g., only with a 5-mile radius). Likewise, a newly registered user may be limited to only sharing the LIV message 150 with one hundred additional users 160 of the viral social network 100. In this scenario, if the LIV message 150 shared by the user 130 is assigned a high quality rating by the additional users 160 (e.g., the LIV message 150 is liked many times and/or passed (i.e., re-shared) many times), the user's 130 ISR may increase, which in turn may allow the user 130 to share future LIV messages 150 beyond the 5-mile radius limit and/or the one hundred user limit. In contrast, if the LIV message 150 shared by the user 130 is deemed to be low quality (e.g., the LIV message 150 is disliked and/or ignored many times by the additional users 160), the user's 130 ISR may decrease, which in turn may result in limiting the number of additional users 160 that will receive the user's 130 future LIV messages 150.

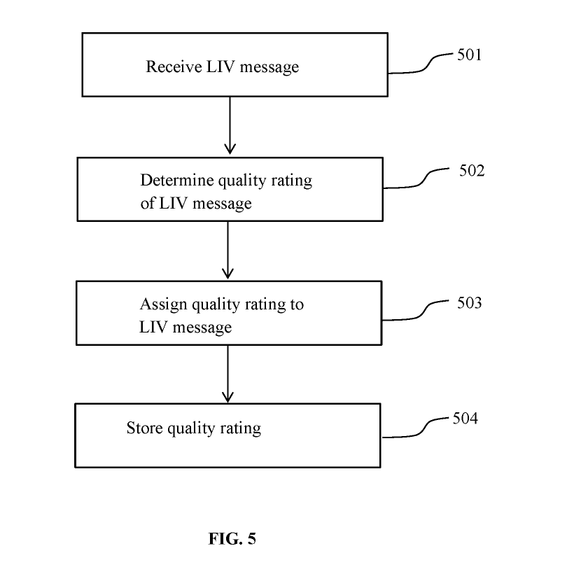

Referring now to FIG. 5, in one embodiment, the user 130 may increase their ISR by obtaining a higher quality rating on their shared content and/or having their content being passed on by additional users 160 of the viral social network. Once the LIV message 150 propagates through the viral social network to additional users 160 (501), those additional users 160 may determine the quality rating of the content of the LIV message 150 (502). The quality of a LIV message 150 may be determined, in part, by the action taken by additional users 160 of the viral social network 100. For example, once the content is shared with the additional users 160, the additional users 160 have the option of liking, disliking, passing, and/or ignoring the content. The quality rating may be assigned to an individual LIV message 150, a group/batch of LIV messages 150, and/or a user 130 and/or group of users. Depending on the action taken, the LIV message 150 may be assigned a quality rating (503), and the quality rating may be stored by the server 110 and/or the database 120 for reference (504).

In one embodiment, the viral social network 100 may comprise any suitable system, module, or analysis engine to determine, assign, modify, and/or remove a quality rating. The quality rating may be affect various factors and/or parameters utilized by the viral social network 100 in determining who receives the LIV message 150. For example, the number of additional users 160 the LIV message 150 is able to be shared with may depend on the quality rating of the user 130. If the user 130 has a lower quality rating, then the viral social network 100 may allow that user 130 to only share LIV messages 150 within a small geographic proximity range (e.g., only within 1-mile instead of 5-miles for another user 160 with higher a higher quality rating).

The quality rating may comprise any suitable system configured to relay information regarding the quality of the LIV message 150. For example, the quality rating may comprise a number scale (e.g., a quality rating between 1-5,1-10, or 1-⁺10), a letter scale (an “A” quality rating signifying higher quality than an “F” quality rating), a heat map, a chart, and/or the like. The quality rating may be assigned/attributed to a LIV message 150 using any suitable system, including affirmative actions taken by the user 130 or plurality of additional users 160 such as clicking a like, dislike, pass, and/or ignore indicator.

In one embodiment, the viral social network 100 may automatically determine a particular user's evaluation of the LIV message 150. For example, if a given user viewing a LIV message 150 takes longer than a predetermined time to take an action (e.g. like, dislike, pass, or ignore), then the viral social network 100 may assign a default action (e.g., the LIV message 150 is ignored by default). Similarly, if at least one additional user 160 receiving the user's 130 content thereafter shares the same content, then the viral social network 100 may automatically determine that the user's 130 content was passed, store that information in the server 110 and/or database 120, and then increase the user's 130 ISR metric in response to their content being passed along.

The additional users 160 receiving the LIV message may like, dislike, pass, and/or ignore a LIV message 150. As discussed above, a user's 130 ISR may be determined, in part, by the quality rating associated with their LIV messages 150 as determined by additional users 160 of the viral social network 100. For example, if a LIV message 150 is liked and/or otherwise approved of, the LIV message 150 may continue to be propagated within the viral social network 100 subject to the other parameters and/or factors in place as described above. The viral social network 100 may be configured to increase the user's 130 ISR. As more and more additional users 160 like the content, the user's 130 ISR may increase in response to the actions of the additional users.

In another example, if the LIV message 150 is disliked by one or more of the additional users 160, then transmission of the LIV message may be halted and/or otherwise inhibited or restricted with respect to those particular users and/or the entire viral social network 100. For example, if one additional user 160 dislikes the LIV message 150, then that message may be prevented from propagating to additional persons within that particular user's social network. If the LIV message 150 receives a sufficient amount of dislikes from multiple additional users 160, then propagation of the LIV message 150 may prevented within the viral social network 100 entirely.

In another example, if the additional users 160 receiving the LIV message 150 from the user 130 choose to pass the LIV message 150 onto more additional users 160, then the original user 130 who shared the LIV message 150 may be rewarded with an increased ISR score. In yet another example, if the LIV message 150 is ignored by the additional users 160, then the viral social network 100 may stop and/or otherwise limit the LIV message 150 from being propagated further within the viral social network 100. When a user's 130 LIV message 150 is ignored by additional users 160, the originating user's 130 ISR may be negatively affected. If a sufficient number (or percentage) of the additional users 160 ignore the content, the viral social network 100 may determine that the LIV message 150 is of low quality and decrease the user's 130 ISR in response.

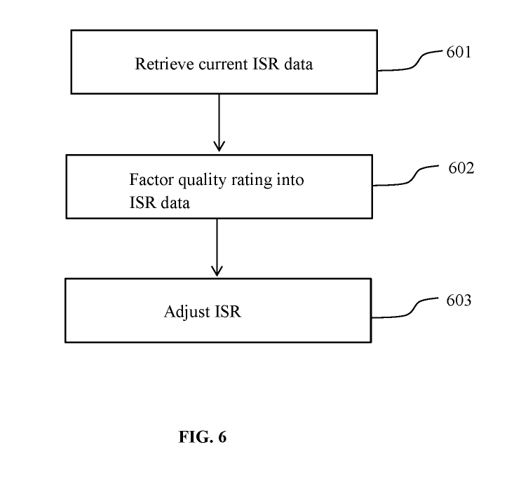

Referring now to FIG. 6, in one embodiment, the user's 130 ISR metric may be calculated/determined in real-time as a given LIV message 150 is being propagated within the viral social network 100. The viral social network 100 may be configured with any suitable system configured to evaluate data in real-time and reach a determination. The viral social network 100 may retrieve current ISR data associated with a user 130 from the server 110 and/or database 120 (601). An algorithm may run on the server 110 which takes into account the actions of the additional users 160 (e.g., the quality rating) who receive the LIV message 150 to determine the user's 130 ISR metric (602).

For example, after the user 130 shares the LIV message 150, the algorithm may receive as inputs information relating to the number of additional users 160 the LIV message 150 propagated to, whether those additional users 160 liked, disliked, passed, and/or ignored the LIV message 150, and the geographical extent of where the LIV message 150 has traveled. Using a combination of multiple factors may allow the algorithm to determine and/or adjust the user's 130 ISR in real-time as the LIV message 150 propagates within the viral social network 100 (603).

The algorithm utilized to determine and/or adjust the user's 130 ISR may also run at predetermined time intervals and/or upon the occurrence of a specific event/trigger. For example, the viral social network 100 may be configured such that the algorithm is run once a day, wherein the ISR of all users of the viral social network 100 is updated. The algorithm may also be configured to run upon the occurrence of an event or trigger. For example, the algorithm may be configured to adjust the user's 130 ISR once the LIV message 150 they shared reaches a certain number of additional users 160, reaches/surpasses a certain geographical area, receives a certain number of likes, and/or the like.

In one embodiment, the viral social network 100 may comprise any suitable system configured to clean up and/or otherwise manage the LIV messages 150 being propagated within the viral social network 100. As more and more users create and share content within the viral social network 100, additional bandwidth and/or storage space may be required to handle the increase in traffic and usage. The cleanup process may utilize any system configured to indicate that a LIV message 150 is to be cleaned up and/or otherwise marked for removal, storage, and/or archiving. The cleanup process may be performed manually by the users and/or the cleanup process may be performed automatically by the viral social network 100.

In one embodiment, the viral social network 100, in conjunction with the server 110 and/or database 120, may store or otherwise maintain every LIV message 150 created and its related data. For example, the database 120 may store information and/or data related to LIV messages 150, such as the date it was created, the user 130 who created the LIV message 150, the content of the LIV message 150, the additional users 160 the LIV message 150 was propagated to, the action taken by the additional users 160, and/or the like.

In one embodiment, the viral social network 100 may associate an expiration with each LIV message. The expiration may comprise any suitable system to evaluate whether a LIV message 150 has expired or should expire. For example, the expiration may comprise a time limit, wherein a LIV message 150 expires after a predetermined time limit (e.g., one hour, one week, one month, etc.). The expiration may also comprise a triggered event, wherein a LIV message 150 expires upon the occurrence of a specific event (e.g., the LIV message 150 expires once it has reached a certain number of additional users 160).

In one embodiment, a user's 130 ISR and a LIV message's 150 quality rating may be considered by the viral social network 100 in determining whether a LIV message 150 should expire. For example, if the additional users 160 receiving the LIV message 150 assign a high quality rating to the LIV message 150, the viral social network 100 may extend and/or otherwise prolong the expiration period of the LIV message 150. In contrast, if the additional users 160 assign a low quality rating to the LIV message 150, the viral social network 100 may be configured to terminate and/or shorten the expiration period of the LIV message 150.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A computer-implemented method of propagating a content within an online social network communicatively coupled to a communication network from a first user to a plurality of additional users of the online social network, comprising:
receiving, over the communication network, by the social network, the content to be propagated within the online social network from a content creation device; and
propagating, by the online social network, the content over the communication network to the plurality of additional users associated with the social network, wherein an amount the content is propagated among the plurality of additional users is determined according to an influence metric relating to the first user.

2. A computer-implemented method according to claim 1, wherein determining a quality rating of the propagated content comprises:
capturing, by the online social network, an action taken by at least one of the additional users, wherein the action taken comprises at least one of liking, disliking, passing, and ignoring the propagated content;
storing, by the online social network, the action taken by the additional user; and
assigning, by the online social network, a quality rating to the propagated content.

3. A computer-implemented method according to claim 2, further comprising updating the influence metric based on the quality rating.

4. A computer-implemented method according to claim 1, wherein the amount the content is propagated to the plurality of additional users is limited to a predetermined geographical proximity range from the content creation device.

5. A computer-implemented method according to claim 4, wherein determining the predetermined geographical proximity range further comprises:
retrieving, by the online social network, the influence metric of the first user;
retrieving, by the online social network, the quality rating of the content; and
determining, by the online social network, the predetermined geographical proximity range using the influence metric and the quality rating.

6. A computer-implemented method according to claim 5, wherein the predetermined geographical proximity range is adjusted based on at least one of the influence metric and the quality rating.

7. A computer-implemented method according to claim 1, wherein the influence metric is determined using a date range.

8. A computer-implemented method according to claim 1, wherein the content creation device comprises an electronic device configured to be communicatively linked to the online social network over the communication network.

9. A computer-implemented method according to claim 1, wherein the content is propagated within the online social network anonymously.

10. A computer-implemented method according to claim 1, wherein the content further comprises at least one of: image, sound, and video.

11. A system for an online social network communicatively coupled to a communication network configured to propagate a content received from a content creation device within the social network from a first user to a plurality of additional users, comprising:
a server communicatively linked to a content creation device and the social network by the communication network, wherein the server is configured to propagate the content over the communication network to a plurality of additional users associated with the social network, wherein an amount the content is propagated among the plurality of additional users is determined according to an influence metric relating to the first user; and
a database communicatively linked to the server and configured to:
store information related to the influence metric; and
provide the influence metric to the server.

12. A system according to claim 11, wherein the server is further configured to determine a quality rating of the propagated content, wherein the server is configured to:
capture an action taken by at least one of the additional users, wherein the action taken comprises at least one of liking, disliking, passing, and ignoring the propagated content;
store the action taken in the database; and
assign a quality rating to the propagated content.

13. A system method according to claim 12, wherein the server is further configured to update the influence metric based on the quality rating.

14. A system according to claim 11, wherein the amount the content is propagated to the plurality of additional users is limited to a predetermined geographical proximity range from the content creation device.

15. A system according to claim 15, wherein the sever is configured to determine the predetermined geographical proximity range, the server configured to:
retrieve the influence metric of the first user;
retrieve the quality rating of the propagated content; and
determine the predetermined geographical proximity range using the influence metric and the quality rating.

16. A system according to claim 15, wherein the predetermined geographical proximity range is adjusted based on at least one of the influence metric and the quality rating.

17. A system according to claim 11, wherein the influence metric is determined using a date range.

18. A system according to claim 11, wherein the content creation device comprises an electronic device configured to be communicatively linked to the online social network over the communication network.

19. A system according to claim 11, wherein the content is propagated within the online social network anonymously.

20. A system according to claim 11, wherein the content further comprises at least one of: image, sound, and video.
